(19) United States
(12) Patent Application Publication
(10) Pub. No.: US 2026/0340487 A1
(43) Pub. Date: Oct. 29, 2026

(54) Exemplar-Guided Code Generation

(71) Applicant: GDM Holding LLC, Mountain View, CA (US)

(72) Inventors: Massimo Nicosia, Zürich (CH); Francesco Piccinno, Zürich (CH); Antonio Trapanese, Zurich (CH)

(21) Appl. No.: 19/190,285

(22) Filed: Apr. 25, 2025

(51) Int. Cl. G06N 20/00

(52) U.S. Cl. CPC G06N 20/00

(57) ABSTRACT

Systems and methods described herein provide obtaining an exemplar-guided training example that includes a training input and a training output. The training input can include input data exemplars representative of a set of input structured data and target data exemplars representative of at least a portion of a set of target structured data. The training output can include a set of computer-executable operations that result in generation of the set of target structured data. A system can process the training input with a machine-learned sequence processing model to generate a model output. The system can evaluate a loss function that compares the model output with the training output. The system can modify one or more values of one or more parameters of the machine-learned sequence processing model based on the loss function.

The present disclosure relates generally to machine learning processes and machine-learned devices and systems. M ore particularly, the present disclosure relates to systems and methods for training and inference using exemplar data structures.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method. The method includes obtaining, by a computing system may include one or more computing devices, an exemplar-guided training example may include a training input and a training output, where the training input may include: one or more input data exemplars representative of a set of input structured data; and one or more target data exemplars representative of at least a portion of a set of target structured data. The method also includes and where the training output may include a set of computer-executable operations that, when performed on the set of input structured data, result in generation of the set of target structured data; processing, by the computing system, the training input with a machine-learned sequence processing model to generate, as an output of the machine-learned sequence processing model, a model output; evaluating, by the computing system, a loss function that compares the model output with the training output; and modifying, by the computing system, one or more values of one or more parameters of the machine-learned sequence processing model based on the loss function. Other embodiments of this aspect include corresponding computer systems, apparatus, and computer programs recorded on one or more computer storage devices, each configured to perform the actions of the methods.

Example implementations may include any combination of one or more of the following features. The method where the set of input structured data may include a set of input tabular data, where the set of target structured data may include a set of target tabular data, and where the set of computer-executable operations may include a set of tabular manipulation operations. The tabular manipulation operations may include database query operations. The database query operations may include SQL operations. The method may include: retrieving the database query operations from an existing code repository. Generating the exemplar-guided training example may include: obtaining the set of input structured data; executing the set of computer-executable operations on the set of input structured data to generate the set of target structured data; and packaging the set of input structured data, the set of target structured data, and the set of computer-executable operations as the exemplar-guided training example. The set of computer-executable operations are randomly sampled from an existing code repository. The set of computer-executable operations are randomly sampled from a set of possible operations included in a computer language. The method may include, after said modifying: receiving, by the computing system, a user-provided prompt, the user-provided prompt may include one or more user-provided input data exemplars and one or more user-provided output data exemplars; processing, by the computing system, the user-provided prompt with the machine-learned sequence processing model to generate, as an output of the machine-learned sequence processing model, an additional set of computer-executable operations; and providing the additional set of computer-executable operations as an output. The method may include: automatically executing the additional set of computer-executable operations to generate completed output structured data. The method may include: automatically extracting the user-provided input data exemplars and the user-provided output data exemplars from an application environment that stores data in a structured format corresponding to the set of target structured data. The application environment may include a spreadsheet application. Said automatically extracting is performed responsive to a user input that highlights or selects a subset of data displayed within the application environment. Said automatically extracting is performed responsive to a drag-and-drop user input. The target structured data may include at least one of: tabular data, PDF data, image data, embedded JSON database literals, or embedded XML database literals. Implementations of the described techniques may include hardware, a method or process, or computer software on a computer-accessible medium.

One general aspect includes a method. The method also includes receiving, by a computing system, a user-provided prompt may include one or more user-provided input data exemplars and one or more user-provided output data exemplars; processing, by the computing system, the user-provided prompt with a machine-learned sequence processing model to generate, as an output of the machine-learned sequence processing model, an additional set of computer-executable operations; and providing the additional set of computer-executable operations as an output. Other embodiments of this aspect include corresponding computer systems, apparatus, and computer programs recorded on one or more computer storage devices, each configured to perform the actions of the methods.

Example implementations may include any combination of the following features. The method where the machine-learned sequence processing model has been trained on exemplar-guided training examples, each exemplar-guided training example may include: one or more input data exemplars representative of a set of input structured data; one or more target data exemplars representative of at least a portion of a set of target structured data; and a set of computer-executable operations that, when performed on the set of input structured data, result in generation of the set of target structured data. Implementations of the described techniques may include hardware, a method or process, or computer software on a computer-accessible medium.

One general aspect includes a computer-implemented method. The computer-implemented method also includes receiving first training input data configured to be included in a data structure type; receiving second training data representative of at least a portion of a set of target training output data; generating target training data associated with the data structure type, the target training data may include executable instructions configured to generate, in response to execution of the executable instructions, target output data; training a model using the first and second training input data, the target training data, and the target output data. Other embodiments of this aspect include corresponding computer systems, apparatus, and computer programs recorded on one or more computer storage devices, each configured to perform the actions of the methods.

Example implementations may include any combination of the following features. The method may include: receiving, via a user interface, a prompt may include structured data configured to be included in the data structure type; receiving, via the user interface, an indication for the model to respond with executable instructions configured to generate the data structure type; and generating, using the model, a response may include the executable instructions, based on the prompt and on the indication; and executing the executable instructions to determine whether the response satisfies one or more response criteria. The one or more response criteria include at least one of: a minimum number of rows of tabular data, a data type selected from a group of qualifying data types, or a sufficient number of data elements within the data structure type. The data structure type may include at least one of: a table, a pdf, or a directory of image data. The target training data and the structured data each may include tabular data. The target training data is configured to be included in the data structure type. Generating the target training data associated with the data structure type may include perturbating the structured data to generate updated structured data. Training the model further may include using the updated structured data. Implementations of the described techniques may include hardware, a method or process, or computer software on a computer-accessible medium.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 shows a block diagram of an example exemplar-guided code generation system configured to implement a computing system, according to example implementations of aspects of the present disclosure;

FIG. 2 shows an example method for training a machine-learned sequence processing model using one or more exemplar-guided training examples, according to example implementations of aspects of the present disclosure;

FIG. 3 shows an example method for using user-provided data to generate a target output, according to example implementations of aspects of the present disclosure;

FIG. 4 shows an example method for training a model and inferring a response based on a prompt, according to example implementations of aspects of the present disclosure.

FIG. 5 is a flow chart diagram illustrating an example method for training a machine-learned model according to example implementations of aspects of the present disclosure;

FIG. 6 is a block diagram of an example processing flow for using machine-learned model(s) to process input(s) to generate output(s) according to example implementations of aspects of the present disclosure;

FIG. 7 is a block diagram of an example sequence processing model according to example implementations of aspects of the present disclosure;

FIG. 8 is a block diagram of an example technique for populating an example input sequence for processing by a sequence processing model according to example implementations of aspects of the present disclosure;

FIG. 9 is a block diagram of an example model development platform according to example implementations of aspects of the present disclosure;

FIG. 10 is a block diagram of an example training workflow for training a machine-learned model according to example implementations of aspects of the present disclosure;

FIG. 11 is a block diagram of an inference system for operating one or more machine-learned model(s) to perform inference according to example implementations of aspects of the present disclosure;

FIG. 12 is a block diagram of an example networked computing system according to example implementations of aspects of the present disclosure;

FIG. 13 is a block diagram of an example computing device according to example implementations of aspects of the present disclosure; and

FIG. 14 is a block diagram of an example computing device according to example implementations of aspects of the present disclosure.

### DETAILED DESCRIPTION

Generally, the present disclosure is directed to machine learning methods and machine-learned devices and systems. M ore particularly, the present disclosure is directed to systems and methods for using specially-tailored structural data to train a machine-learned model, such as, for example, a sequence processing model. The specially-tailored structural data can improve training of the model so that outputs better align with target outputs for target structural data inputs.

Sequence processing models (e.g., which can be or include so-called “large language models”, “large multimodal models”, “vision-language models”, etc.) are generally effective for natural language understanding and generation. However, sequence processing models are less effective with certain types of structured or specially-formatted data that deviates from conventional natural language patterns. For instance, specific data types such as tabular data, domain-specific data (e.g., legal citations), and/or graphical data (e.g., JPEGs, scientific charts/graphs) require adherence to strict structural conventions. Traditional sequence processing models rely primarily on unstructured or loosely structured text corpora and thus fail to capture the intricacies of these formats. Consequently, when users input prompts containing these specialized formatted data, the model often misinterprets, reformats, and/or distorts information, which can result in inaccurate or unreliable responses.

Disclosed herein are improved systems and methods for training an sequence processing model using specially-formatted and/or structured data. The improved embodiments can allow the model to learn and retain the rules, patterns, and/or dependencies within that data structure/format type. Unlike conventional approaches, which treat all text as undifferentiated linguistic content, this method incorporates structured formatting focus into the model's training process. This can be done, for example, by exposing the model to training sequences that explicitly maintain hierarchical, positional, and/or semantic relationships within the structured data. Thus, during inference, the model can more accurately interpret, preserve, and/or respond to user prompts containing structured data.

To do so, the computing system can obtain one or more exemplar-guided training examples. The exemplar-guided training examples can include training input and training output. The training input can include one or more input data exemplars and one or more target data exemplars. The input data exemplars can be representative of a set of input structured data. The input structured data can, for example, include tabular data. The target data exemplars can be representative of a portion of a set of target structured data. The target structured data may additionally or alternatively include tabular data.

The training output can include computer-executable operations that can be executed to generate the set of target structured data. The target structured data may include a complete set of structured data (e.g., a complete table) of which the target data exemplars may be a portion.

The computing system can process the training input with a machine-learned sequence processing model. The computing system may process the training input to generate a model output using the machine-learned sequence processing model. The computing system can evaluate a loss function that compares the model output with the training output and then modify certain values of one or more parameters of the machine-learned sequence processing model based on the loss function.

In some instances, the set of input structured data can include a set of input tabular data. Additionally or alternatively, the set of target structured data can include a set of target tabular data. In some embodiments, the set of computer-executable operations include a set of tabular manipulation operations, such as database query operations (e.g., SQL operations).

In some embodiments, the computing system can automatically generate exemplar-guided training examples. The computing system may generate the exemplar-guided training examples by obtaining the set of input structured data and executing the set of computer-executable operations on the set of input structured data to generate the set of target structured data. The computing system can package the set of input structured data, the set of target structured data, and/or the set of computer-executable operations as the exemplar-guided training example. In some embodiments, the set of computer-executable operations are randomly and/or algorithmically sampled from an existing code repository. For example, the system can sample code snippets from a repository, such as a database included in and/or remote from the computing system. Additionally or alternatively, the computer-executable operations can be sampled (e.g., randomly, algorithmically) from a set of possible operations included in a computer language.

The computing system may allow for inferences using the trained machine-learned model. For example, after training the model, the computing system may receive a user-provided prompt (e.g., via a user interface). The user-provided prompt can include one or more user-provided input data exemplars and/or one or more user-provided output data exemplars. The computing system can process the user-provided prompt with the machine-learned sequence processing model to generate inference computer-executable operations as an output. The inference computer-executable operations can get executed (e.g., automatically) by the computing system to generate completed output structured data (e.g., a complete table).

In some implementations, the computing system can extract (e.g., automatically) the user-provided input data exemplars and/or the user-provided output data exemplars from an application environment that stores data in a structured format corresponding to the set of target structured data. For examples, the application environment may include a spreadsheet application. By extracting the input data exemplars and/or the output data exemplars, the computing system may be responsive to a user input that highlights and/or otherwise selects a subset of data displayed within the application environment. In some cases, extracting the input/output data exemplars can be performed responsive to a drag-and-drop user input. The target structured data can include tabular data, PDF data, and/or image data.

Example embodiments according to some aspects of the present disclosure can provide for a number of technical effects and benefits, such as improvements to computing technology (e.g., machine learning technology). For example, by integrating structured formatting focus into the sequence processing model's training process, a computationally efficient method for handling specialized data types can reduce error rates while reducing computational overhead associated with post-processing corrections. Additionally or alternatively, embodiments disclosed herein can enhance the model's ability to generalize structured patterns without overfitting to overly rigid templates, thereby improving both flexibility and accuracy.

Embodiments described herein can improve the efficiency of prompt processing by allowing the sequence processing model to recognize and/or process structured inputs with improved accuracy. Traditional models often require external, rule-based post-processing to correct format errors, but embodiments described herein can enable the model to natively understand and generate structured content. This may not only reduce latency but also reduce unnecessary computational cycles. For example, in some instances, systems and methods according to some aspects of the present disclosure can provide similar-quality (e.g., same-quality, etc.) machine-learned inference outputs at a reduced cost (e.g., reduced computational cost of inference, reduced training cost, reduced data collection cost, etc.) compared to some alternative implementations.

Various example implementations are described herein with respect to the accompanying Figures.

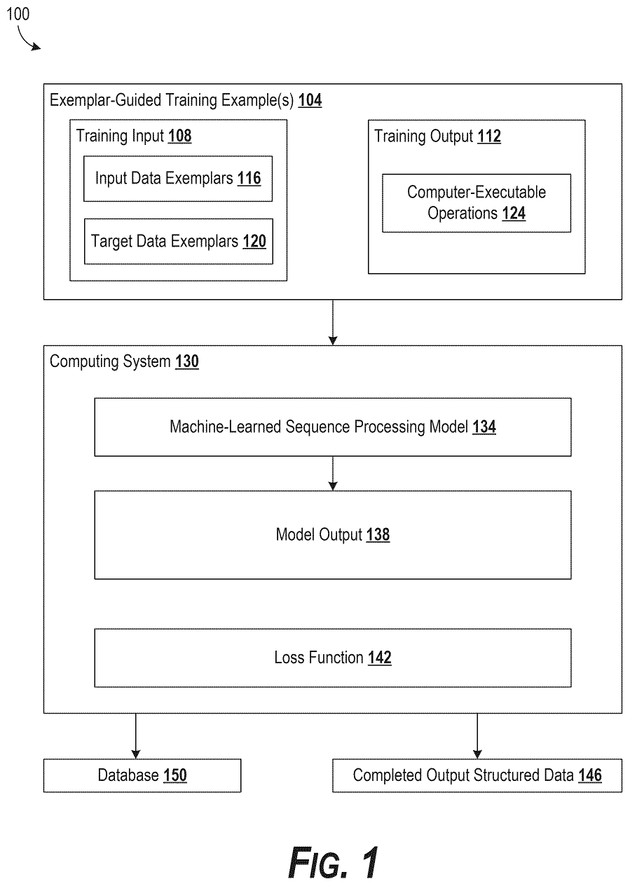

Referring now to FIG. 1, a block diagram illustrates an example exemplar-guided code generation system 100 configured to implement a computing system 130, according to example implementations of aspects of the present disclosure. The computing system 130 can receive a plurality of types of data for training and/or inference. For example, the computing system 130 can receive one or more exemplar-guided training example(s) 104. The exemplar-guided training example(s) 104 can include one or more types of training data, such as training input 108 and training output 112. The training input 108 can include input data exemplars 116 and/or target data exemplars 120. The training output 112 can include computer-executable operations 124.

The exemplar-guided training example(s) 104 can be useful for specifying a type of data and/or formatting that may be desired for output by the computing system 130. The exemplar-guided code generation system 100 can generate structured outputs that align with predefined target data exemplars 120 using a machine-learned sequence processing model 134. The machine-learned sequence processing model 134 can be trained using exemplar-guided training example(s) 104, which can include the training input 108 together with the training output 112. The training input 108 and training output 112 can help refine the ability of the machine-learned sequence processing model 134 to produce computer-executable operations 124 that, when executed, generate outputs in a target format. The target format may include computer executable instructions (e.g., code) that generate data in the target format. The target format can be PDF data, image data, JSON literals, other literals, etc.

During training, the computing system 130 processes the training input 108, which may include structured data, prompts, and/or specifications describing the desired output.

The machine-learned sequence processing model 134 can generate the model output 138, which may contain an executed version of the computer-executable operations 124. These computer-executable operations 124 can transform the training input 108 into a structured format that matches the target data exemplars 120. To evaluate how well the generated computer-executable operations 124 aligns with expectations, the computing system 130 compares the resulting structured data to the target data exemplars 120, applying a loss function 142 to measure discrepancies.

The loss function 142 guides iterative updates to the machine-learned sequence processing model 134, improving its ability to infer the correct model output 138 from new exemplar-guided training example(s) 104. By continuously adjusting model parameters, the machine-learned sequence processing model 134 enhances its accuracy in generating executable code that, when executed, produces outputs matching or approaching the training output 112. These updates help the system generalize beyond the training set, allowing it to correctly structure outputs even when presented with novel inputs.

The result of the loss function 142 is a numerical value representing an error, which the machine-learned sequence processing model 134 seeks to minimize over time. By iteratively adjusting the parameters of the machine-learned sequence processing model 134, the system learns to generate outputs that more accurately match the expected structure and content of the training output 112. The loss function 142 guides optimization algorithms, such as stochastic gradient descent (SGD) or A dam, which can update the weights used in the machine-learned sequence processing model 134 based on the computed loss. During training, the computing system 130 processes numerous exemplar-guided training example(s) 104, each contributing to adjustments in the machine-learned sequence processing model 134 based on the error calculated by the loss function 142.

Different types of loss function 142 can be used depending on the nature of the task. For example, in some embodiments, a Mean Squared Error (MSE) function is used. Additionally or alternatively, for classification tasks the loss function 142 may include a Cross-Entropy Loss function. When generating computer-executable operations 124, the loss function 142 may evaluate a syntactic correctness of the generated computer-executable operations 124, the model output 138, and/or the similarity of the model output 138 to the training output 112.

Once trained, the exemplar-guided code generation system 100 can process new inputs and generate completed output structured data 146 in real-time. The computing system 130 can take a new input, apply the trained machine-learned sequence processing model 134, and produce the model output 138 containing the required computer-executable operations according to the computer-executable operations 124. These operations are executed to produce structured results that match the intended format, such as PDFs, tables, or reports.

By maintaining a feedback loop between input data exemplars 116, generated model output 138, and/or the loss function 142, the computing system 130 continuously improves its alignment with predefined formatting and execution requirements. This promotes concordance such that the final completed output structured data 146 meets the specifications outlined by the target data exemplars 120, allowing the system to reliably generate high-quality structured data across various domains.

The training input 108 can include one or more input data exemplars 116 that are representative of input structured data. For example, the input structured data may include a set of values extracted from a dataset such as a table. In some embodiments, the input structure data includes (e.g., if the target data exemplars 120 include PDF data) plain text without formatting, extracted OCR text from images, markdown/HTML/LaTex before conversion, and/or CSV files before structuring. Additionally or alternatively, the input structure data can (e.g., if the target data exemplars 120 include image data) include raw images without annotations, unprocessed figures, scanned text, and/or images without compression or embedding. For other target data exemplars 120, such as embedded JSON or XML database literals, the input structure data can include unformatted JSON dumps, API responses, database exports before formatting or structuring, raw XML files with nested tags, metadata, and/or unformatted hierarchical data before being structured into readable output.

The training input 108 can additionally or alternatively include one or more target data exemplars representative of at least a portion of a set of target structured data. The target structured data can include, for example fully formatted PDF documents with proper font styles, tables, headings, images, and/or other structured content. In some embodiments, the target structured data can include JSON and/or XML data correctly formatted and/or embedded within structured documents, tables, and/or visualizations. The target structured data can represent a format that a format of the completed output structured data 146 should seek to model.

The training output 112 can include a set of computer-executable operations that generate the target structured data, such as when the operations are performed on the set of input structured data of the input data exemplars 116. The computing system 130 can process the training input 108 with the machine-learned sequence processing model 134 to generate the model output 138. The computing system 130 can evaluate the loss function 142 by comparing the loss function 142 with the training output 112. The computing system 130 can modify one or more values of one or more parameters of the machine-learned sequence processing model based on the loss function.

In some embodiments, the input structured data of the input data exemplars 116 includes input tabular data. In such embodiments, the target structured data of the target data exemplars 120 can include target tabular data that represents a desired format of the tabular data. In some embodiments, the tabular manipulation operations can include database query operations, such as SQL operations or other language operations. For example, the computing system 130 may retrieve the database query operations from a database 150. The database 150 may be from a remote computing system and/or from the computing system 130. The computer-executable operations 124 can include tabular manipulation operations that, when executed, generate the target structured data.

In some embodiments, the computing system 130 can itself at least partially generate the exemplar-guided training example(s) 104. This may be done, for example, by obtaining the input structured data of the input data exemplars 116 and executing the computer-executable operations 124 on the input structured data to generate the target structured data of the target data exemplars 120. The computing system 130 can package the input structured data, the target structured data, and the computer-executable operations 124 as the exemplar-guided training example(s) 104.

In some embodiments, the computer-executable operations 124 can be randomly sampled from an existing code repository. For example, the computer-executable operations 124 can be randomly sampled from a set of possible operations included in a given computer language. The existing code repository may be taken from the database 150.

In some embodiments, the computing system 130 can receive a user-provided prompt (e.g., after training the machine-learned sequence processing model 134). The user-provided prompt can include one or more user-provided input data exemplars and/or output data exemplars. The computing system 130 can process the user-provided prompt with the machine-learned sequence processing model 134 to generate an additional set of computer-executable operations, which may be separate from the computer-executable operations 124 that were used to train the computing system 130. The computing system 130 can output the additional set of computer-executable operations additionally or alternatively to the completed output structured data 146.

The computing system 130 can automatically execute the additional set of computer-executable operations to generate completed output structured data, which may be separate from or additional to the completed output structured data 146. Additionally or alternatively, the computing system 130 can automatically extract the user-provided input data exemplars and the user-provided output data exemplars from an application environment, such as a spreadsheet application, that stores data in a structured format corresponding to the set of target structured data. For example, a user may select a set of data (e.g., from a user interface having the application environment) that is to be used as the set of target structured data. This may be done in a number of ways, such as by highlighting, dragging, copying, or otherwise selecting the desired data that is displayed within the application environment. For example, the extraction may be in response to a user's drag-and-drop input. For example, the user may select a set of tabular data, PDF data, image data (e.g., a snippet of an image), JSON database literals, XML database literals, and/or any other target structured data that a user may want to use to guide the machine-learned sequence processing model 134.

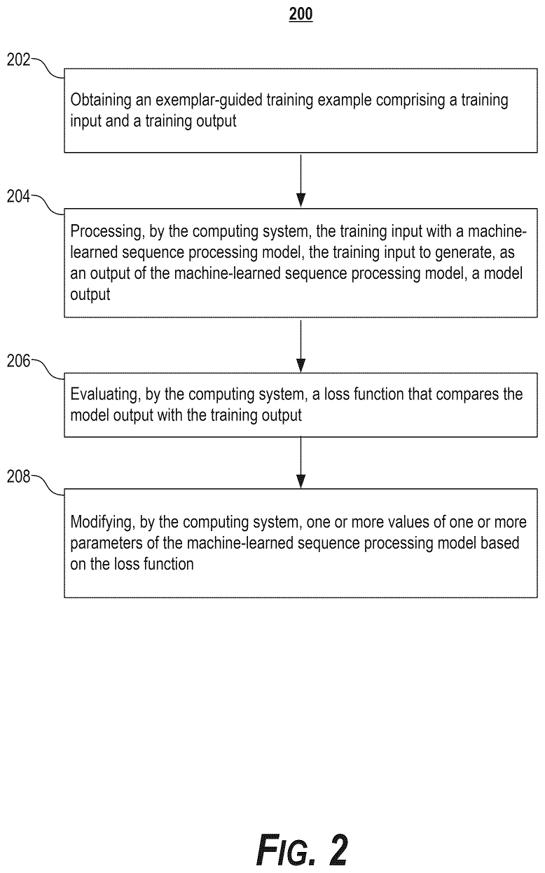

FIG. 2 shows an example method 200 for training a machine-learned sequence processing model using one or more exemplar-guided training examples. Each respective portion of example method 200 can be performed by any (or any combination) of one or more computing devices. Moreover, one or more portion(s) of example method 200 can be implemented on the hardware components of the device(s) described herein, for example, to train one or more systems or models. FIG. 2 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 2 is described with reference to elements/terms described with respect to other systems and figures for exemplary illustrated purposes and is not meant to be limiting. One or more portions of example method 200 can be performed additionally, or alternatively, by other systems.

The method 200 includes, at 202, obtaining an exemplar-guided training example. The exemplar-guided training example can include a training input and a training output. The training input can include one or more input data exemplars representative of a set of input structured data, and/or one or more target data exemplars representative of at least a portion of a set of target structured data. In some embodiments, the set of input structured data includes a set of input tabular data. The set of target structured data can include a set of target tabular data. Additionally or alternatively, the set of computer-executable operations can include a set of tabular manipulation operations. The training output can include a set of computer-executable operations that, when performed on the set of input structured data, result in generation of the set of target structured data. The tabular manipulation operations can include database query operations that are configured to query a database. The database query operations can include SQL operations. In some embodiments, the method 200 includes retrieving the database query operations from a database, which may be in communication with the computing system and/or a part of the computing system. In some embodiments, the set of computer-executable operations can be randomly or arbitrarily sampled from an existing code repository. Additionally or alternatively, the set of computer-executable operations can be randomly or arbitrarily sampled from a set of possible operations included in a computer language.

The exemplar-guided training example can be, for example, the one or more exemplar-guided training example(s) 104 of FIG. 1. The training input can be the training input 108. The training output can be the training output 112. The input data exemplars can be the input data exemplars 116. The target data exemplars can be the target data exemplars 120. The computer-executable operations can be the computer-executable operations 124. The computing system can be the computing system 130.

The method 200 includes, at 204, processing the training input with a machine-learned sequence processing model. The training input can be processed to generate a model output, as an output of the machine-learned sequence processing model. As described herein, the machine-learned sequence processing model can include a neural network, a transformer-based model, and/or other statistical learning framework. The machine-learned sequence processing model can execute a series of computations to transform the training input into an output prediction. This transformation may involve a plurality of layers of processing, which may include embedding layers, attention mechanisms, recurrent connections, and/or other computational operations that allow the model to infer relationships between elements within the input sequence. The generated model output can correspond to an estimate by the machine-learned sequence processing model of a desired structured output based on the training input.

The method 200 includes, at 206, evaluating a loss function to compare the model output with the training output. The loss function can represent a mathematical measure of how well the predictions of the machine-learned sequence processing model align with the actual results provided in the training dataset. in sequence-to-sequence tasks, The loss function can include a cross-entropy loss (e.g., in sequence-to-sequence tasks) to compare predicted sequences to target sequences. The loss function can include a mean squared error (MSE) and/or mean absolute error (MAE) for regression-based tasks. In evaluating the loss function, the system can assess the model's accuracy and identify where its predictions deviate from a desired structured output (e.g., desired structured output format). By computing the loss for each training example, the system can track performance across multiple iterations and determine whether the model is improving over time.

The method 200 includes, at 208, modifying one or more values of one or more parameters of the machine-learned sequence processing model based on the loss function. The system may modify the one or more values using a gradient. For example, the system may use a stochastic gradient descent (SGD), an A dam, and/or RM Sprop. The system can compute gradients of the loss function with respect to the parameters of the machine-learned sequence processing model and/or update these parameters in order to reduce or even minimize a loss. This process may be performed iteratively over multiple training cycles until the machine-learned sequence processing model reaches a state where the loss is minimized and a determined accuracy of the outputs is maximized.

In some embodiments, the method also includes generating the exemplar-guided training example. For example, it may be beneficial to generate a large number of machine-learned examples, such as when an accuracy of the desired output is to be increased. The exemplar-guided training example can be generated by, for example, obtaining the set of input structured data and executing the set of computer-executable operations on the set of input structured data to generate the set of target structured data. The system can then package a least the set of input structured data, the set of target structured data, and the set of computer-executable operations as the exemplar-guided training example. This process may be repeated multiple times to generate a plurality of the exemplar-guided training examples.

This self-training may be done, for example, by applying data augmentation techniques, synthetic data generation, and/or self-training approaches to create additional training examples. Data augmentation may involve modifying existing input structured data in a systematic way, such as by introducing controlled variations, adding noise (e.g., perturbations), and/or transforming the data while maintaining its core structure. For example, for structured data that includes tabular data, augmentation techniques may include altering numerical values within predefined limits, changing categorical labels while preserving logical consistency, and/or introducing simulated outlier cases. These transformations can allow the machine-learned sequence processing model to more accurately generalize from a diverse set of inputs.

Additionally or alternatively, the system may create new structured data examples using synthetic data generation. The new structured data examples can follow a common set of statistical properties as the original dataset. The system may use generative adversarial networks (GANs), variational autoencoders (VAEs), and/or rule-based synthesis methods to produce structured input-target pairs that resemble real-world exemplars. For example, if the machine-learned sequence processing model is being trained to convert unstructured text into structured database entries, synthetic data generation may involve generating artificial text samples with corresponding structured outputs based on predefined linguistic patterns. The system can then incorporate these additional training examples into the model training process. Generating synthetic training data can increase the size of the training dataset to increase the accuracy of the training.

In some examples, the system may self-train to infer outputs on unlabeled data. For example, the machine-learned sequence processing model may be used to infer outputs on new, unlabeled data, and the highest-confidence predictions can be added back into the training set as additional labeled examples. This may be done iteratively to allow the system to expand its training dataset autonomously. Using self-training, the system can reinforce patterns that the machine-learned sequence processing model has already learned and/or refine its decision-making ability over time. For example, the system may process a set of raw input records using an initial model and then validate and/or refine the predicted structured outputs using rule-based constraints and/or human verification.

As an example, a user may receive the following prompt that includes elements of a training input and a training output (labeled for reference):
You're a code generation agent that produces valid SQL. Given the following input tables:

TABLE A
(PersonID, Name, Country)

| | | |
|---|---|---|
| 0001, | | |
| Alice, IT | | |
| 0002, Bob, IT | | |
| 1000, Kat, IT | | |
| 0003, Charlie, CH | {close oversize brace} | input data exemplar #1 |
| 0004, Max, | | |
| CH | | |
| 0005, Urs, CH | | |
| 0006, Vlad, CH | | |

TABLE B
(PersonID, Income)

| | | |
|---|---|---|
| 1000, | | |
| 100 | | |
| 0001, 100 | | |
| 0002, 190 | | |
| 0003, 110 | {close oversize brace} | input data exemplar #2 |
| 0004, 200 | | |
| 0005, 115 | | |
| 0006, 215 | | |

And given the following table containing few rows (not all) of what the target table should look like:

(Country, Income)

| IT, 390 | | |
|---|---|---|
| CH, | {close oversize brace} | target data exemplar |
| 225 | | |

Produce the SQL query that will result in a complete target table. The output table can be the result of applying filters and aggregation functions.

A machine-learned sequence processing model that has not been trained according to the improved methods disclosed herein may output something like the following:

| | | |
|---|---|---|
| SELECT A. Country, SUM (B. Income) AS Incom | | |
| FROM A | | |
| JOIN B ON | {close oversize brace} | untrained output |
| A. PersonID = B. PersonID | | |
| GROUP BY A. Country; | | |

Although at a high-level, the general sequence of operations in the untrained output may be partially correct (e.g., join & aggregation), the model output is missing a filtering operation (e.g., “WHERE Income<200”) despite an explicit hint in the prompt. The untrained model does not realize that the table resulting from executing the model output does not cover/contain the rows specified in the target data exemplar from the training input.

After training according to one or more of the improved methods described herein, the machine-learned sequence processing model may output something like the following:

| | | |
|---|---|---|
| SELECT A. Country, SUM (B. Income) AS | | |
| Income | | |
| FROM A | | |
| JOIN B ON A. PersonID = B. PersonID | {close oversize brace} | training output |
| WHERE Income < 200 | | |
| GROUP BY A. Country; | | |

This improved model output shown above is more useful to the user, based on what the input data exemplar and target data exemplar, as well as the user's prompt, included. For example, it includes the desired filtering operation indicated by the user's prompt. Thus, such an output may be used as a training output.

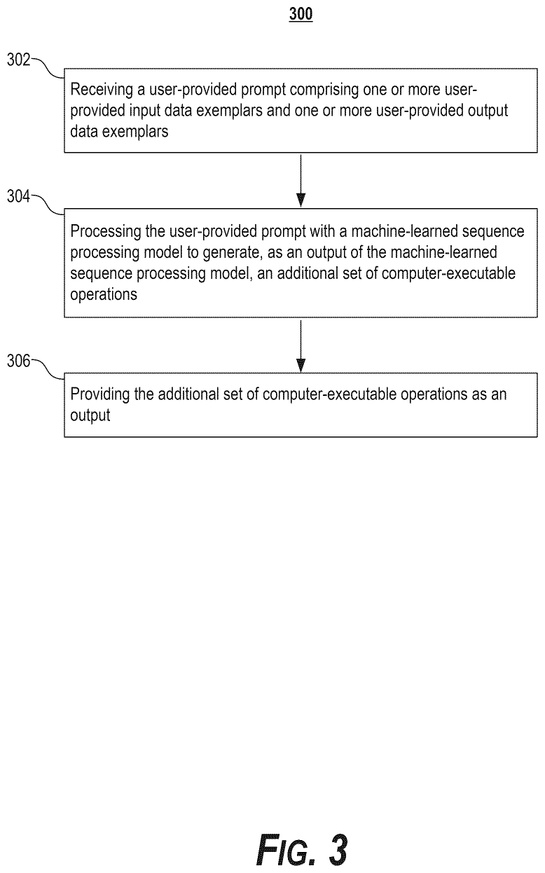

FIG. 3 shows an example method 300 for using user-provided data to generate a target output. One or more portion(s) of example method 300 can be implemented by a computing system that includes one or more computing devices such as, for example, computing systems described with reference to the other figures. Each respective portion of example method 300 can be performed by any (or any combination) of one or more computing devices. Moreover, one or more portion(s) of example method 300 can be implemented on the hardware components of the device(s) described herein, for example, to train one or more systems or models. FIG. 3 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 3 is described with reference to elements/terms described with respect to other systems and figures for exemplary illustrated purposes and is not meant to be limiting. One or more portions of example method 300 can be performed additionally, or alternatively, by other systems.

The method 300 includes, at 302, receiving a user-provided prompt. The user-provided prompt can include one or more user-provided input data exemplars and/or one or more user-provided output data exemplars. The method 300 includes, at 304, processing the user-provided prompt with the machine-learned sequence processing model to generate an additional set of computer-executable operations as an output of the machine-learned sequence processing model.

The method 300 includes, at 306, providing the additional set of computer-executable operations as an output of the computing system and/or of the machine-learned sequence processing model. In some embodiments, the system can automatically execute the additional set of computer-executable operations to generate completed output structured data. Additionally or alternatively, the system can automatically extract the user-provided input data exemplars and the user-provided output data exemplars from an application environment that stores data in a structured format corresponding to the set of target structured data. For example, the application environment can include a spreadsheet application, an image, machine-executable code, a PDF, and/or other data from a related and/or separate application. The system may automatically extract the input data exemplars in response to a user input that selects (e.g., highlights, drags-and-drops, inputs, etc.) a subset of data displayed within the application environment. Additionally or alternatively, the target structured data can include tabular data, PDF data, or image data, embedded JSON database literals, and/or embedded XML database literals.

In some embodiments, the system can analyze the user-provided prompt to identify patterns, structures, and/or transformations present in the input and/or output data exemplars. Based on the identified relationships, the machine-learned sequence processing model can generate an additional set of computer-executable operations that define how to process similar inputs to achieve the desired outputs. This may involve inferring data mappings, transformation logic, and/or computational rules that can be generalized beyond the specific exemplars provided by the user. For example, if the input exemplars include raw textual data and the output exemplars represent structured database entries, the system may generate executable operations that extract relevant entities, normalize formats, and/or organize the data into a desired structured format.

Additionally or alternatively, the system may refine the additional set of computer-executable operations by iteratively applying them to new input data and evaluating the resulting outputs against one or more predefined accuracy parameters. In some cases, the system can incorporate reinforcement learning and/or feedback mechanisms to allow the user to validate and/or modify the generated operations. The generated operations can be stored, indexed, and/or made available for reuse. In some embodiments, these operations can be included as an output of the computing system and/or of the machine-learned sequence processing model.

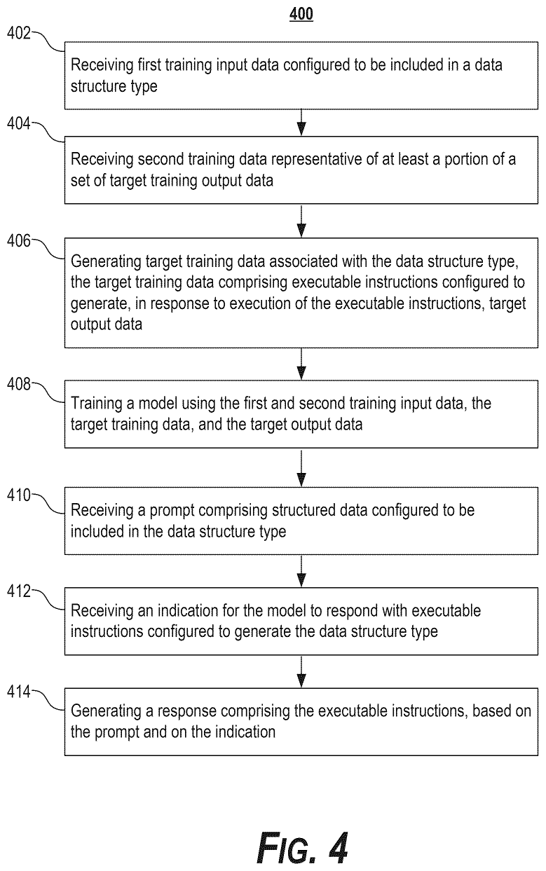

FIG. 4 shows an example method 400 for training a model and inferring a response based on a prompt. One or more portion(s) of example method 400 can be implemented by a computing system that includes one or more computing devices such as, for example, computing systems described with reference to the other figures. Each respective portion of example method 400 can be performed by any (or any combination) of one or more computing devices. Moreover, one or more portion(s) of example method 400 can be implemented on the hardware components of the device(s) described herein, for example, to train one or more systems or models. FIG. 4 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 4 is described with reference to elements/terms described with respect to other systems and figures for exemplary illustrated purposes and is not meant to be limiting. One or more portions of example method 400 can be performed additionally, or alternatively, by other systems.

The method 400 includes, at 402, receiving first training input data configured to be included in a data structure type. The first training input data can include one or more input data exemplars representative of a set of input structured data, and/or one or more target data exemplars representative of at least a portion of a set of target structured data. In some embodiments, the set of input structured data includes a set of input tabular data. The set of target structured data can include a set of target tabular data. Additionally or alternatively, the set of computer-executable instructions configured to generate target output data can include a set of tabular manipulation operations. These operations can include database query operations, such as SQL operations, which may be retrieved from a database in communication with or a part of the computing system. In some embodiments, the computer-executable operations can be randomly or arbitrarily sampled from an existing code repository or from a set of possible operations included in a programming language.

The method 400 includes, at 404, receiving second training data representative of at least a portion of a set of target training output data. The second training data can include one or more target data exemplars representative of at least a portion of a set of target structured data. The target structured data can include structured tabular data, and the corresponding executable instructions may define transformations that, when applied to the first training input data, result in the generation of target structured data. The transformations may involve data extraction, data normalization, and/or data structuring processes that align input data with expected output formats.

The method 400 includes, at 406, generating target training data associated with the data structure type, the target training data comprising executable instructions configured to generate, in response to execution of the executable instructions, target output data. The target training data may include a set of computer-executable operations that, when performed on the input structured data, generate the target structured data. These executable instructions may be derived from a database query, transformation logic, or a predefined set of computational rules applied to the input data exemplars. The process of generating the target training data may involve extracting relevant entities, normalizing formats, and/or structuring data in a format suitable for further model training. The target training data may be configured to be included in the data structure type. In some embodiments, generating the target training data associated with the data structure type includes perturbating the structured data to generate updated structured data. The method may include using the updated structured data. in some embodiments, the updated structured data may itself be used in further training the model, as further described herein (e.g., with regard to FIGS. 2-3).

The method 400 includes, at 408, training a model using the first and second training input data, the target training data, and the target output data. The model may be a machine-learned sequence processing model that executes a series of computations to transform the training input data into an output prediction. The model training process may involve multiple computational layers, including embedding layers, attention mechanisms, recurrent connections, and other operations that allow the model to infer relationships within the input sequence.

The model may include a loss function that can be evaluated. The loss function may be evaluated to compare the model-generated output with the target training data, allowing for iterative refinement of the model's parameters through optimization techniques such as stochastic gradient descent (SGD), A dam, or RM Sprop.

In some embodiments, the method includes executing the executable instructions to determine whether the response satisfies one or more response criteria. The response criteria can include, for example, a minimum number of rows of tabular data, a data type selected from a group of qualifying data types, a sufficient number of data elements within the data structure type, or the like. The data structure type may be any of those described herein, such as a table, a PDF, or a directory of image data. Determining whether the response satisfies the one or more response criteria may be evaluated by the model.

The method 400 includes, at 410, receiving, via a user interface, a prompt comprising structured data configured to be included in the data structure type. The prompt can include user-provided input data exemplars or user-defined queries representing specific data structures or transformation requests. The structured data in the prompt may be automatically extracted from an application environment, such as a spreadsheet application, a PDF document, or a structured database entry. The system may analyze the prompt to identify patterns, structures, and/or transformations needed to process the input data and generate the expected output data.

The method 400 includes, at 412, receiving, via the user interface, an indication for the model to respond with executable instructions configured to generate the data structure type. For example, the indication can be received via the user interface based on various user actions such as clicking a button (e.g., an “export as code” button), using context menu (e.g., a “right-click” context menu), as part of a drag and drop operation, and/or via other input mechanisms. The indication can include user-defined constraints, preferences, or transformation logic that should be applied to the structured data in the prompt. The system may infer computational rules, data mappings, and/or transformation logic based on the user-provided prompt and generate an additional set of computer-executable instructions to process similar inputs and achieve the desired outputs.

The method 400 includes, at 414, generating, using the model, a response comprising the executable instructions, based on the prompt and on the indication. The response may include a set of computer-executable operations that define how to transform the structured data input into a target structured format. These operations can include SQL query generation, data normalization routines, entity extraction functions, or other computational procedures necessary to derive structured output data. Additionally, the generated response can be refined iteratively by applying the operations to new input data and evaluating the results against predefined accuracy parameters. In some cases, reinforcement learning or user feedback mechanisms may be employed to validate and enhance the quality of the generated executable instructions.

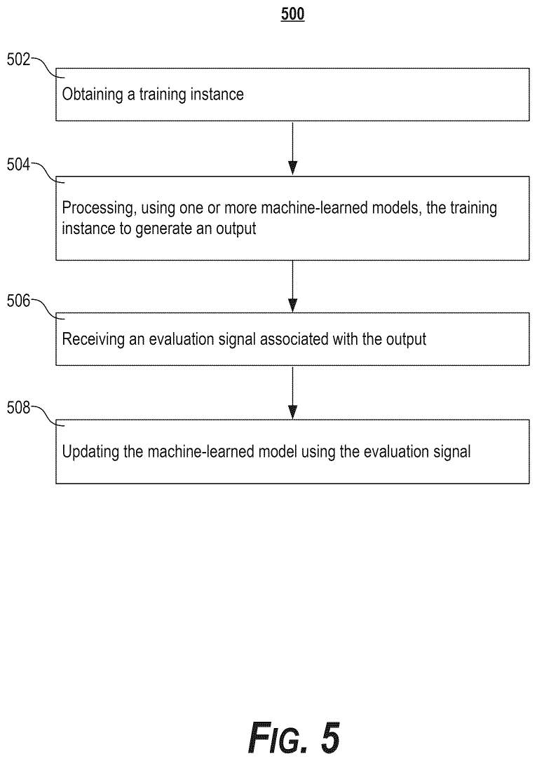

FIG. 5 depicts a flowchart of a method 500 for training one or more machine-learned models according to aspects of the present disclosure. For instance, an example machine-learned model can include a machine-learned sequence processing model 134 (of FIG. 1), or a system in which such a model is a part (e.g., the exemplar-guided code generation system 100, the computing system 130).

One or more portion(s) of example method 500 can be implemented by a computing system that includes one or more computing devices such as, for example, computing systems described with reference to the other figures. Each respective portion of example method 500 can be performed by any (or any combination) of one or more computing devices. Moreover, one or more portion(s) of example method 500 can be implemented on the hardware components of the device(s) described herein, for example, to train one or more systems or models. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 500 can be performed additionally, or alternatively, by other systems.

At 502, example method 500 can include obtaining a training instance. A set of training data can include a plurality of training instances divided between multiple datasets (e.g., a training dataset, a validation dataset, or testing dataset). A training instance can be labeled or unlabeled. Although referred to in example method 500 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 504, example method 500 can include processing, using one or more machine-learned models, the training instance to generate an output. The output can be directly obtained from the one or more machine-learned models or can be a downstream result of a chain of processing operations that includes an output of the one or more machine-learned models.

At 506, example method 500 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 508, example method 500 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 500 can include implementing a number of generalization techniques (e.g., weight decays, dropouts, etc.) to improve the generalization capability of the models being trained.

In some implementations, example method 500 can be implemented for training a machine-learned model from an initialized state to a fully trained state (e.g., when the model exhibits a desired performance profile, such as based on accuracy, precision, recall, etc.).

In some implementations, example method 500 can be implemented for particular stages of a training procedure. For instance, in some implementations, example method 500 can be implemented for pre-training a machine-learned model. Pre-training can include, for instance, large-scale training over potentially noisy data to achieve a broad base of performance levels across a variety of tasks/data types.

In some implementations, example method 500 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 500 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 500 can be implemented to execute parameter-efficient fine-tuning methods, such as Low-Rank Adaptation (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

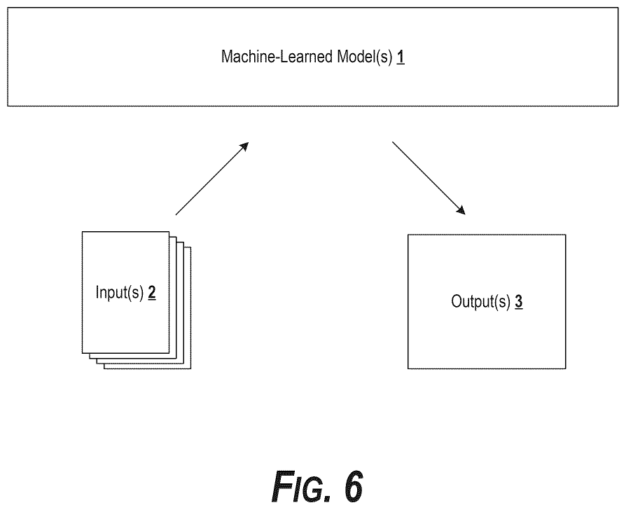

FIG. 6 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of the exemplar-guided code generation system 100, the computing system 130, the machine-learned sequence processing model 134, etc. Although various features, variations, and implementations described below are described with respect to machine-learned model(s) 1, it is to be understood that such features, variations, and implementations are to be understood as described with respect to each of exemplar-guided code generation system 100, the computing system 130, the machine-learned sequence processing model 134, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

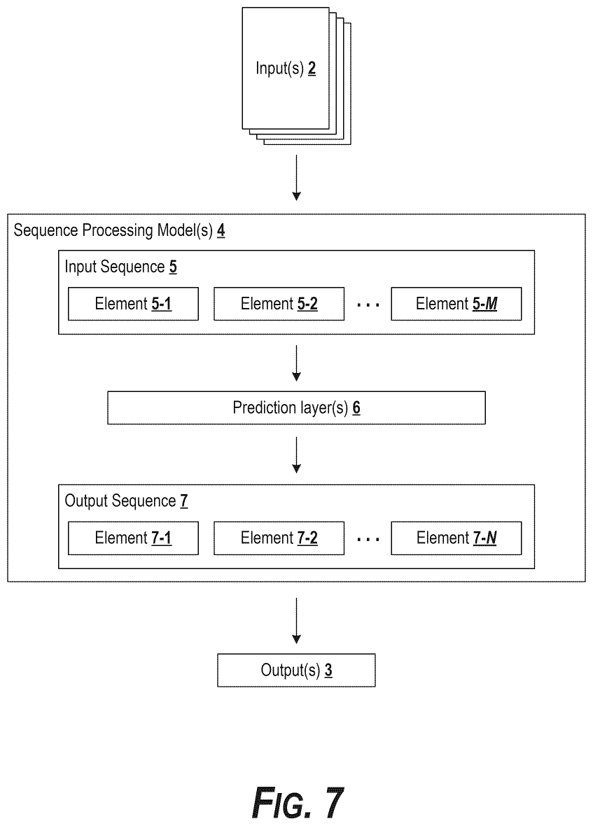

FIG. 7 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, GOOGLE, https://arxiv.org/abs/2403.08295; Gemma 2: Improving Open Language Models at a Practical Size, GOOGLE, https://arxiv.org/abs/2408.00118.

Sequence processing model(s) 4 can process one or multiple types of data simultaneously. Variations of language models that can perform joint vision and language tasks may be referred to as “Vision-Language Models,” or VLM s. Example VLM s include models described in PaliGemma: A versatile 3B VLM for transfer, GOOGLE, https://arxiv.org/abs/2407.07726; PaliGemma 2: A Family of Versatile VLM s for Transfer, GOOGLE, https://arxiv.org/abs/2412.03555; Flamingo: a Visual Language Model for Few-Shot Learning, GOOGLE, https://arxiv.org/abs/2204.14198; PaLI: A Jointly-Scaled Multilingual Language-Image Model, GOOGLE, https://arxiv.org/abs/2209.06794.

Sequence processing model(s) 4 can be multimodal. Example multimodal sequence processing models include, for instance, models described in Gemini: A Family of Highly Capable Multimodal Models, GOOGLE, https://arxiv.org/abs/2312.11805; Gemini 1.5: Unlocking multimodal understanding across millions of tokens of context, GOOGLE, https://arxiv.org/abs/2403.05530.

Other example sequence processing models can operate to generate outputs or receive inputs in specific domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

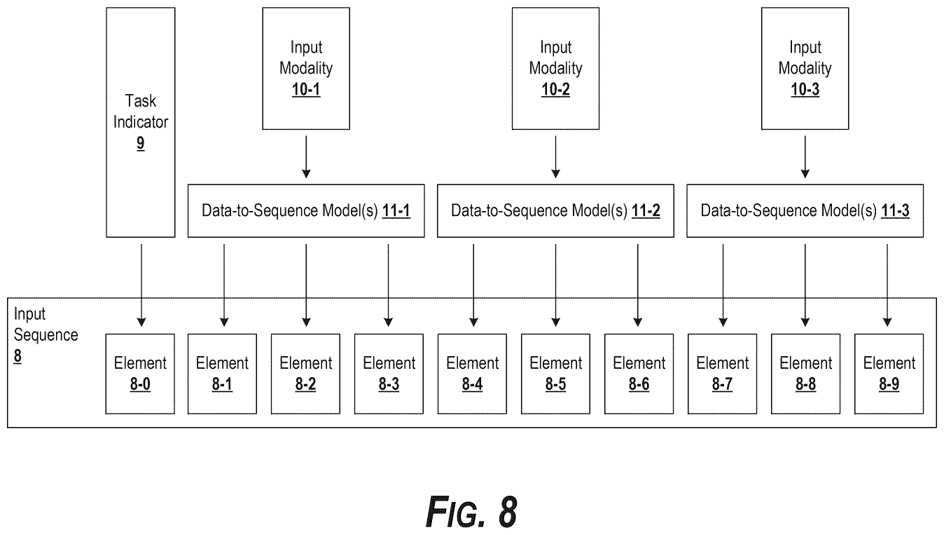

FIG. 8 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

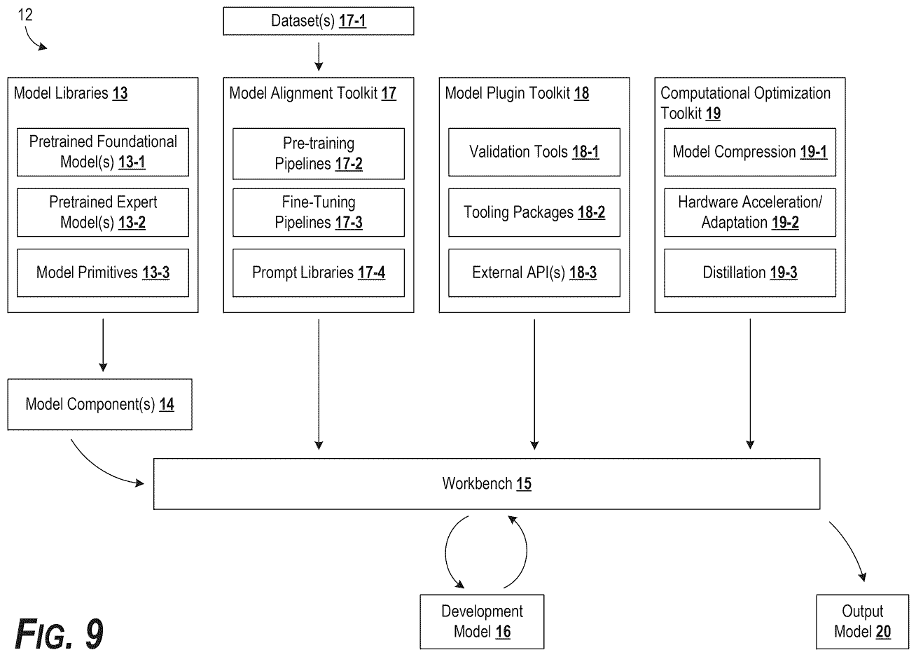

FIG. 9 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

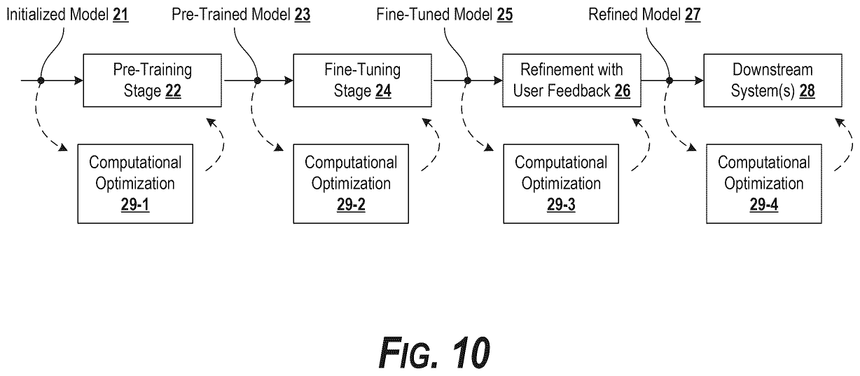

FIG. 10 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

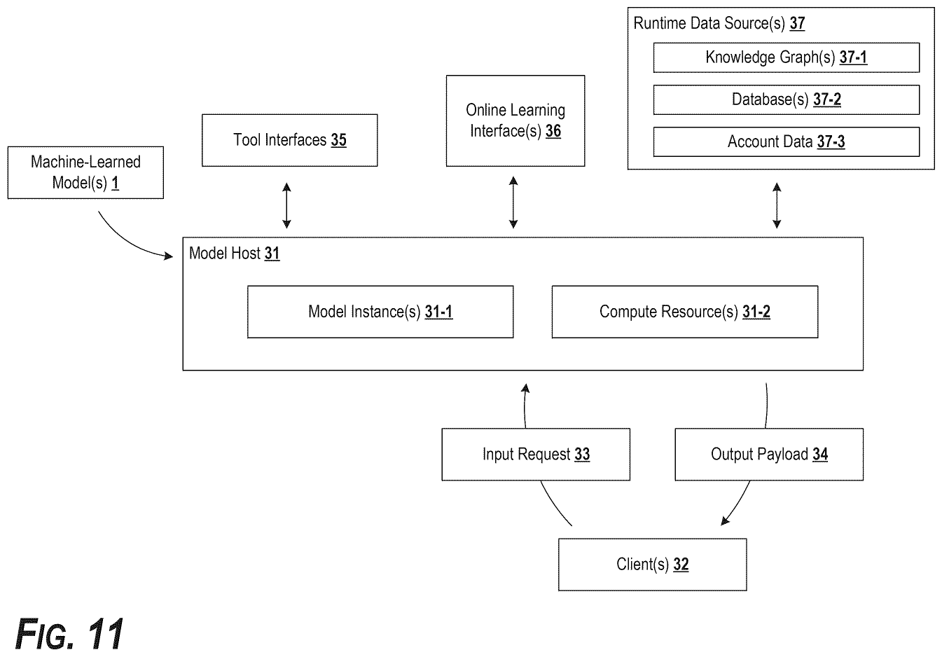

FIG. 11 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote A Pls. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. A s another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

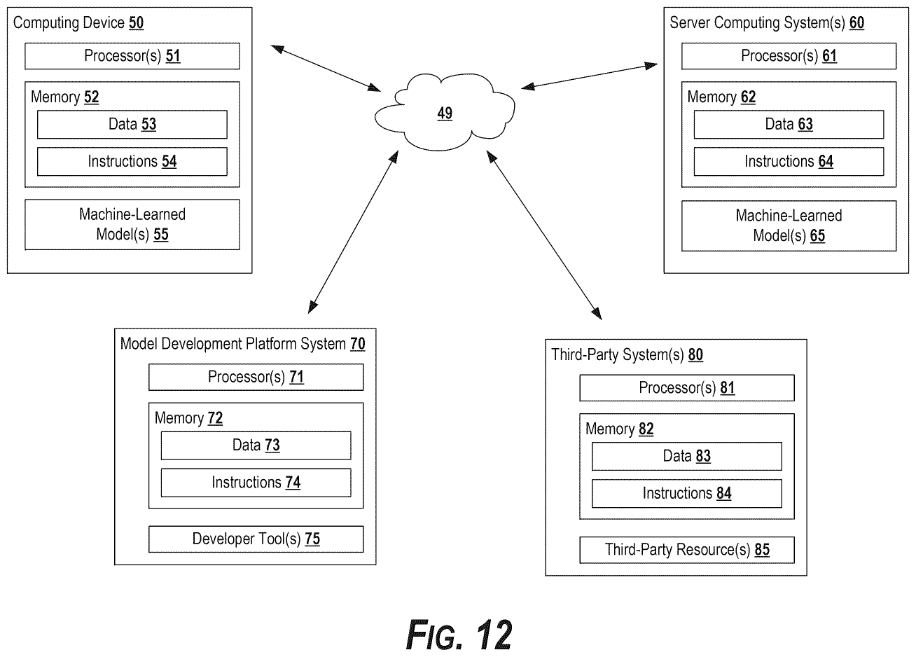

FIG. 12 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an A SIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an A SIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an A SIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 12 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

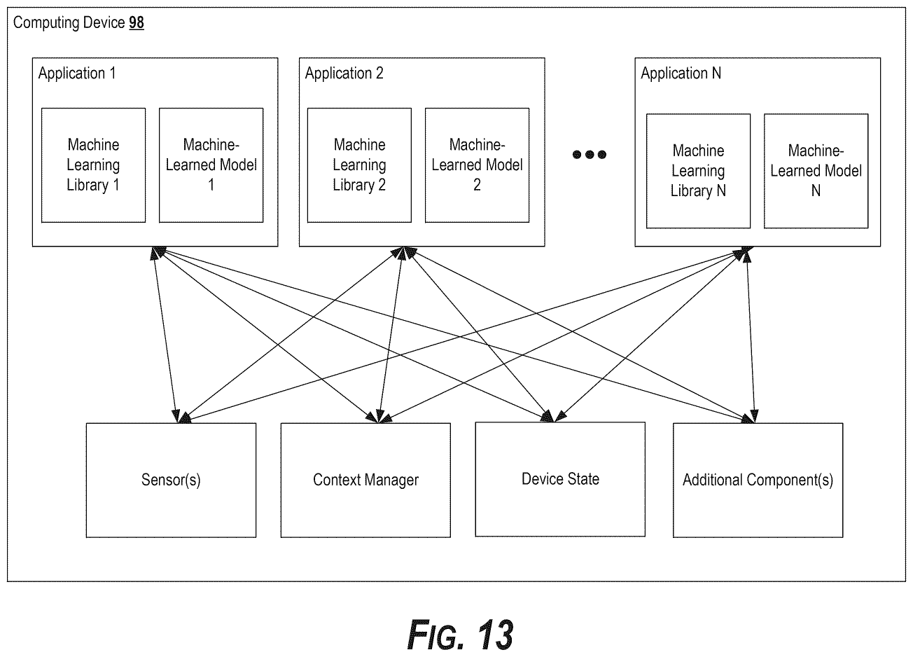

FIG. 13 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 13, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

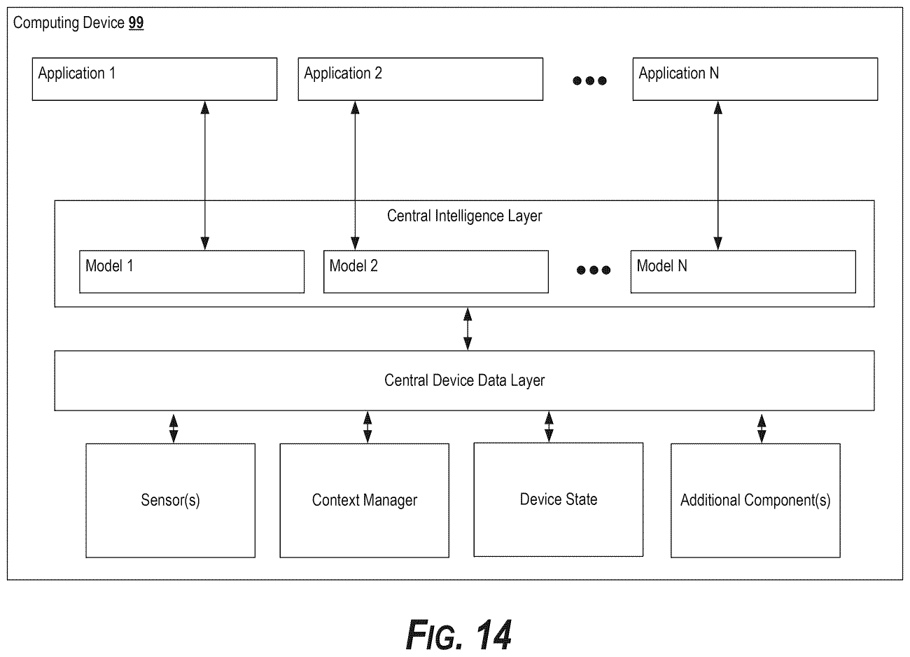

FIG. 14 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 14, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 14, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, comprising:
obtaining, by a computing system comprising one or more computing devices, an exemplar-guided training example comprising a training input and a training output, wherein the training input comprises:
one or more input data exemplars representative of a set of input structured data; and
one or more target data exemplars representative of at least a portion of a set of target structured data;
and wherein the training output comprises a set of computer-executable operations that, when performed on the set of input structured data, result in generation of the set of target structured data;
processing, by the computing system, the training input with a machine-learned sequence processing model to generate, as an output of the machine-learned sequence processing model, a model output;
evaluating, by the computing system, a loss function that compares the model output with the training output; and
modifying, by the computing system, one or more values of one or more parameters of the machine-learned sequence processing model based on the loss function.

2. The method of claim 1, wherein the set of input structured data comprises a set of input tabular data, wherein the set of target structured data comprises a set of target tabular data, and wherein the set of computer-executable operations comprise a set of tabular manipulation operations.

3. The method of claim 2, wherein the tabular manipulation operations comprise database query operations.

4. The method of claim 3, wherein the database query operations comprise SQL operations.

5. The method of claim 3, further comprising:
retrieving the database query operations from an existing code repository.

6. The method of claim 1, further comprising generating the exemplar-guided training example, wherein generating the exemplar-guided training example comprises:
obtaining the set of input structured data;
executing the set of computer-executable operations on the set of input structured data to generate the set of target structured data; and
packaging the set of input structured data, the set of target structured data, and the set of computer-executable operations as the exemplar-guided training example.

7. The method of claim 6, wherein the set of computer-executable operations are randomly sampled from an existing code repository.

8. The method of claim 6, wherein the set of computer-executable operations are randomly sampled from a set of possible operations included in a computer language.

9. The method of claim 1, further comprising, after said modifying:
receiving, by the computing system, a user-provided prompt, the user-provided prompt comprising one or more user-provided input data exemplars and one or more user-provided output data exemplars;
processing, by the computing system, the user-provided prompt with the machine-learned sequence processing model to generate, as an output of the machine-learned sequence processing model, an additional set of computer-executable operations; and
providing the additional set of computer-executable operations as an output.

10. The method of claim 9, further comprising:
automatically executing the additional set of computer-executable operations to generate completed output structured data.

11. The method of claim 9, further comprising:
automatically extracting the user-provided input data exemplars and the user-provided output data exemplars from an application environment that stores data in a structured format corresponding to the set of target structured data.

12. The method of claim 11, wherein the application environment comprises a spreadsheet application.

13. The method of claim 11, wherein said automatically extracting is performed responsive to a user input that highlights or selects a subset of data displayed within the application environment.

14. The method of claim 11, wherein said automatically extracting is performed responsive to a drag-and-drop user input.

15. The method of claim 11, wherein the target structured data comprises at least one of: tabular data, PDF data, image data, embedded JSON database literals, or embedded XML database literals.

16. A method, comprising:
receiving, by a computing system, a user-provided prompt comprising one or more user-provided input data exemplars and one or more user-provided output data exemplars;
processing, by the computing system, the user-provided prompt with a machine-learned sequence processing model to generate, as an output of the machine-learned sequence processing model, an additional set of computer-executable operations; and
providing the additional set of computer-executable operations as an output.

17. The method of claim 16, wherein the machine-learned sequence processing model has been trained on exemplar-guided training examples, each exemplar-guided training example comprising:
one or more input data exemplars representative of a set of input structured data;
one or more target data exemplars representative of at least a portion of a set of target structured data; and
a set of computer-executable operations that, when performed on the set of input structured data, result in generation of the set of target structured data.

18. A computer-implemented method, comprising:
receiving first training input data configured to be included in a data structure type;
receiving second training data representative of at least a portion of a set of target training output data;
generating target training data associated with the data structure type, the target training data comprising executable instructions configured to generate, in response to execution of the executable instructions, target output data;
training a model using the first and second training input data, the target training data, and the target output data.

19. The method of claim 18, further comprising:
receiving, via a user interface, a prompt comprising structured data configured to be included in the data structure type;
receiving, via the user interface, an indication for the model to respond with executable instructions configured to generate the data structure type; and
generating, using the model, a response comprising the executable instructions, based on the prompt and on the indication; and
executing the executable instructions to determine whether the response satisfies one or more response criteria.

20. The method of claim 19, wherein the one or more response criteria include at least one of: a minimum number of rows of tabular data, a data type selected from a group of qualifying data types, or a sufficient number of data elements within the data structure type.

21. The method of claim 18, wherein the data structure type comprises at least one of: a table, a PDF, or a directory of image data.

22. The method of claim 18, wherein the target training data and the structured data each comprise tabular data.

23. The method of claim 18, wherein the target training data is configured to be included in the data structure type.

24. The method of claim 18, wherein generating the target training data associated with the data structure type comprises perturbating the structured data to generate updated structured data.

25. The method of claim 24, wherein training the model further comprises using the updated structured data.
